(19) United States
(12) Patent Application Publication
(10) Pub. No.: US 2005/0015031 A1
(43) Pub. Date: Jan. 20, 2005

(54) Chair

(76) Inventor: Chuan Shen Lin, Changhua County (TW)

Correspondence Address: BACON & THOMAS, PLLC, 625 SLATERS LANE, FOURTH FLOOR, ALEXANDRIA, VA, 22314, US

(21) Appl. No.: 10/620,338

(22) Filed: Jul. 17, 2003

(51) Int. Cl. A61H 15/00

(52) U.S. Cl. 601/115; 601/122

(57) ABSTRACT

A chair includes a seat, a backrest, four legs, and a massage device positioned in the back and/or the backrest. The massage device consists of a frame and plural units of two rows of massage rollers. Each massage roller has plural annular projections and a center hole. An elongate shaft extends through the massage rollers of each row and pivotally connected to a side plate at two ends of each row. Two side connect plates combine pivotally the massage rollers rows with the frame by means of center short shafts pivotally connected with the side connect plates. So the two rows of the massage rollers can be rotated by movement of a user's body to get massage.

### BACKGROUND OF THE INVENTION

1. Field of the invention

This invention relates to a chair, particularly to one provided with a massage device in the seat and/or the backrest or the footrest for a user to sit and massage the bottom, the back or the feet at the same time.

2. Description of Prior Art

Conventional chairs can be classified into many kinds, and most popular ones are:
(1) A first one 1 is shown in FIG. 1, very simple one with a seat made of rattan or bamboo, or a soft material, only for sitting and resting on the backrest, such as a dining chair, a desk chair, etc.
(2) A second one 2 is shown in FIG. 2, like a sofa composed of springs and foam rubber or leather, very comfortable, elegant and luxuriant.
(3) A third one 3 is shown in FIG. 3, also like a massage chair, mostly used in a guest room, further provided with a complicated massage device consisting of a motor and massage rollers for a sitter to receive massaging actions at the same time in sitting. So this chair is quite expensive.

### SUMMARY OF THE INVENTION

This invention is to offer a chair having a seat, a back or a footrest provided with a simple massage device for a sitter to sit and perform massage by sitter's own movement at the same time, with low cost in manufacture.

The feature of the invention is a massage device consisting of a frame, and plural units of two rows of massage rollers positioned in the frame. Then the massage device can form a massage surface for a sitter to make massage to the bottom or the back or the feet by moving the body portion to be massaged on the massage surface for elevating blood circulation.

### BRIEF DESCRIPTION OF DRAWINGS

This invention will be better understood by referring to the accompanying drawings, wherein:

FIG. 1 is a perspective view of a first conventional chair;

FIG. 2 is a perspective view of a second conventional chair;

FIG. 3 is a perspective view of a third conventional chair;

FIG. 4 is a perspective view of a chair in the present invention;

FIG. 5 is an exploded perspective view of the chair in the present invention;

FIG. 6 is an exploded perspective view of a massage device in the present invention;

FIG. 7 is a side view of a massage roller unit in the present invention;

FIG. 8 is a side view of the massage roller unit revolving in the present invention;

FIG. 9 is a side cross-sectional view of the massage device positioned in the seat of the chair in the present invention;

FIG. 10 is a side cross-sectional view of the massage device positioned in the backrest of the chair in the present invention;

FIG. 11 is a side view of a massage device in the seat of the chair in the present invention;

FIG. 12 is a side view of the massage device added with a transmitting member in the present invention;

FIG. 13 is a side view of the massage device added with the transmitting member under operating condition in the present invention; and,

FIG. 14 is a side cross-sectional view of a massage device provided in a footrest in a chaise longue in the present invention.

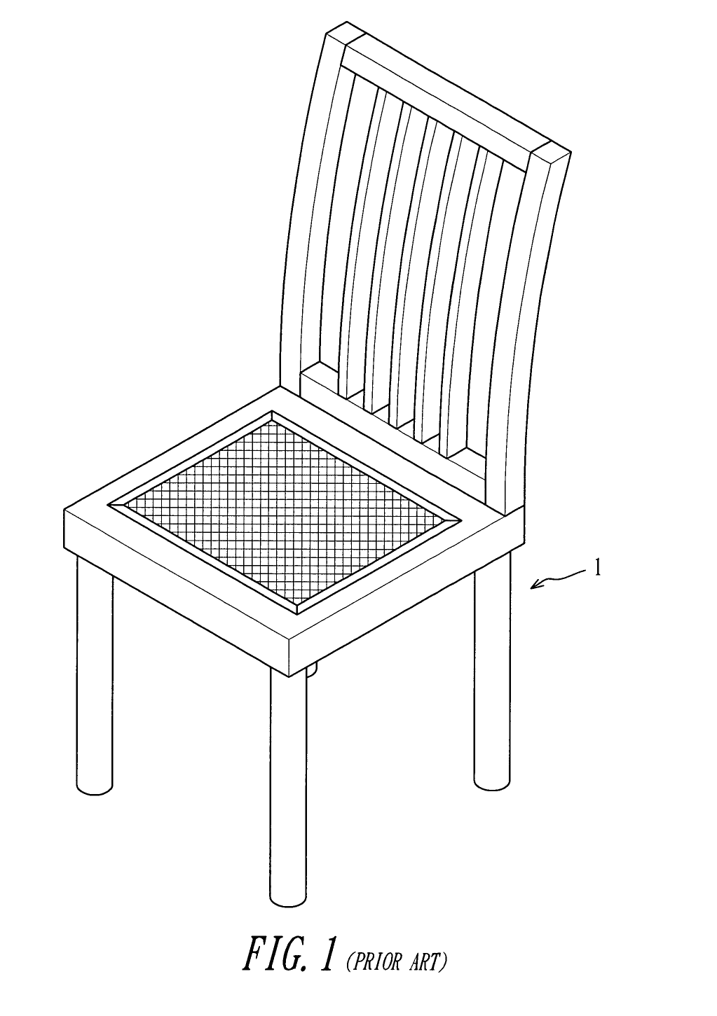

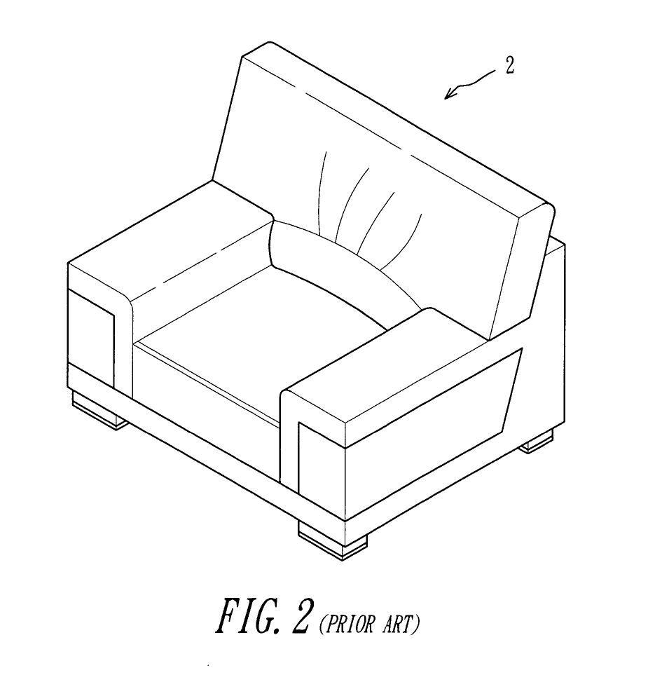

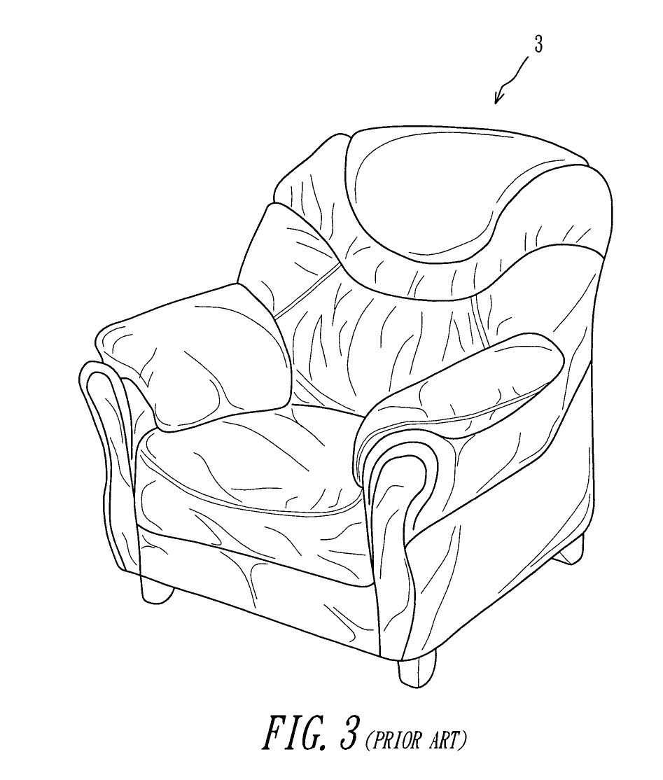

### DETAILED DESCRIPTION OF THE PREFERRED EMBODIMENT

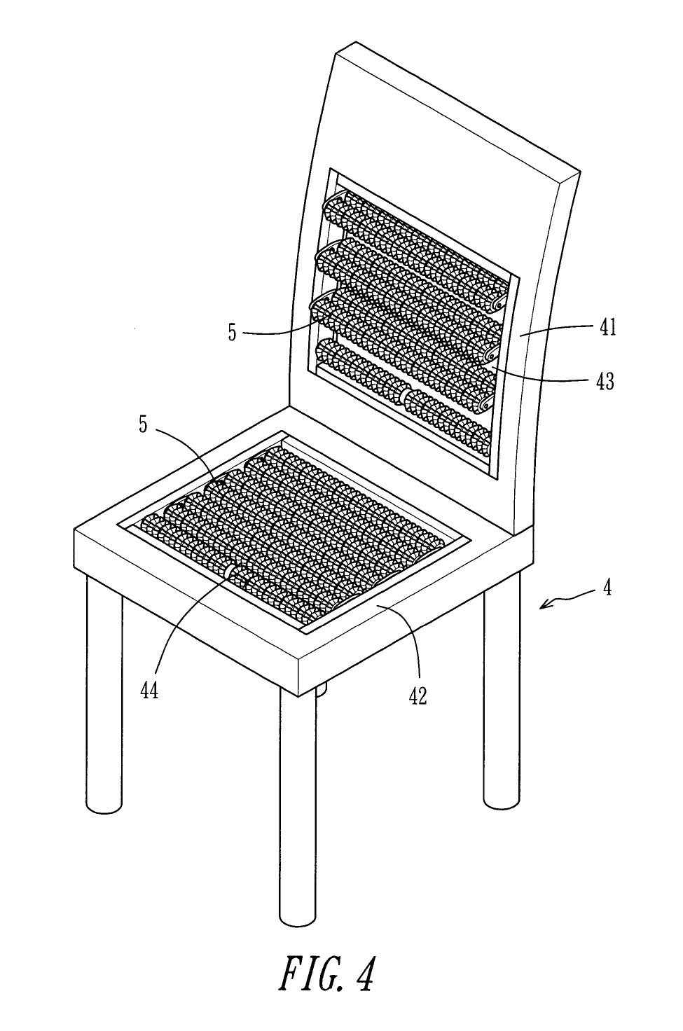

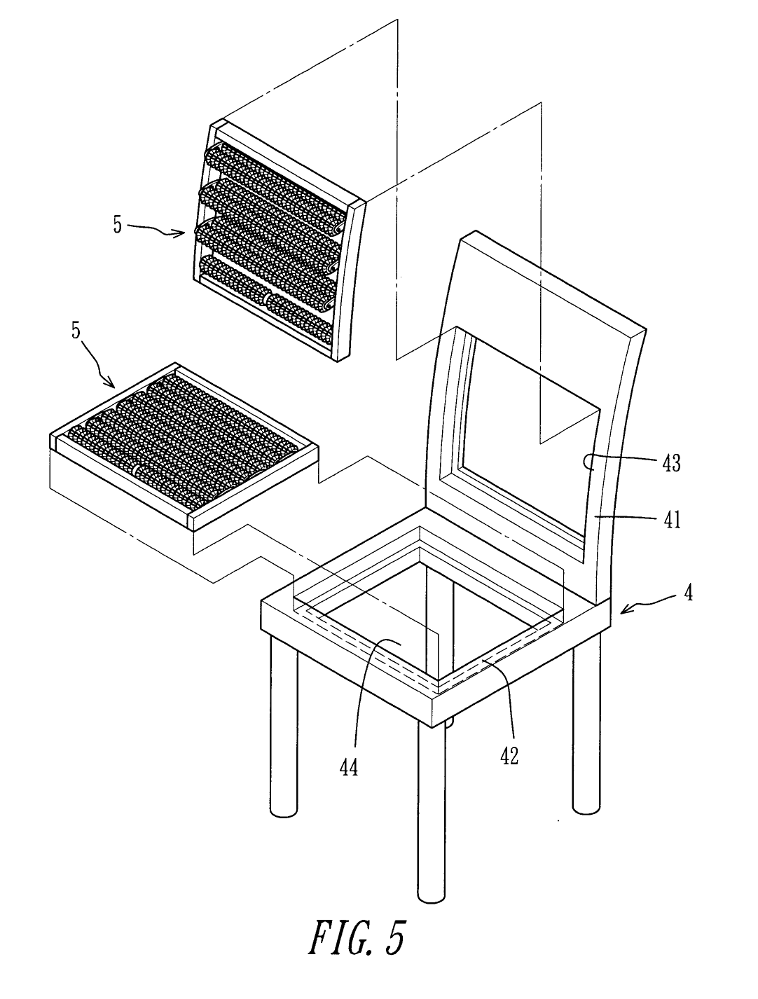

A preferred embodiment of a chair in the present invention, as shown in FIGS. 4 and 5, includes a backrest 41, a seat 42, four legs, a massage device 5 provided in the backrest 41 and/or the seat 42. The backrest 41 is provided with a frame chamber 43 for the massage device 5 to be positioned therein, and the seat 42 is provided with a frame chamber 44 for the massage device 5.

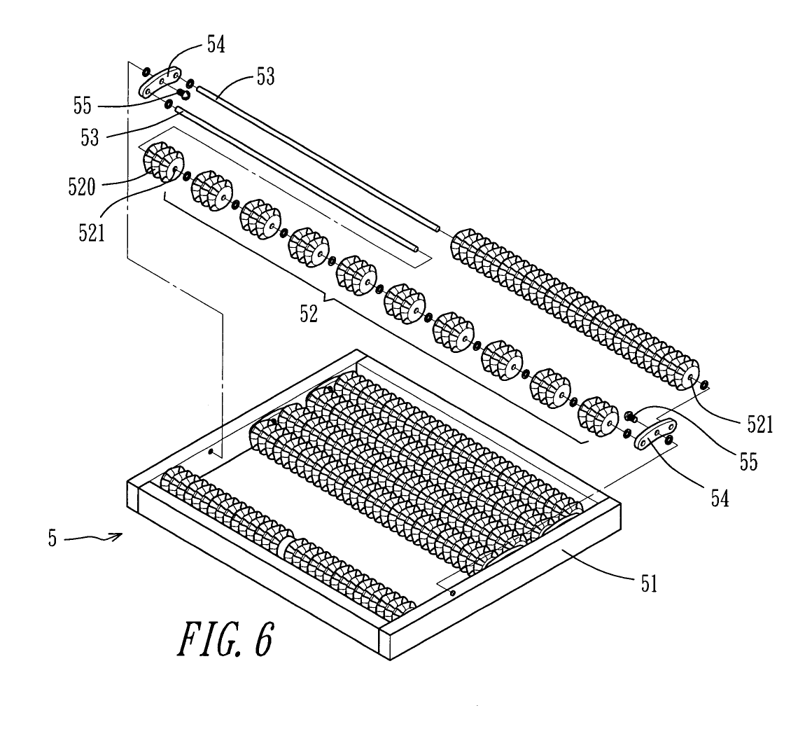

The massage device 5, as shown in FIG. 6, consists of a frame 51 and plural units of two rows of massage rollers 52 respectively formed with a plurality of annular massage projections 520 and a center hole 521, an elongate shaft 53 extending through each row of the massage rollers 52 to form the row of continual massage rollers 52. Then two elongate shafts 53 combined with the two rows of massage rollers 52 are pivotally combined in the frame 51. Thus the massage device 5 may have a single massage surface formed by the single row of massage rollers 52 with the single shaft 53, or a double massage surface formed by the two rows of massage rollers 52 with the two shafts 53.

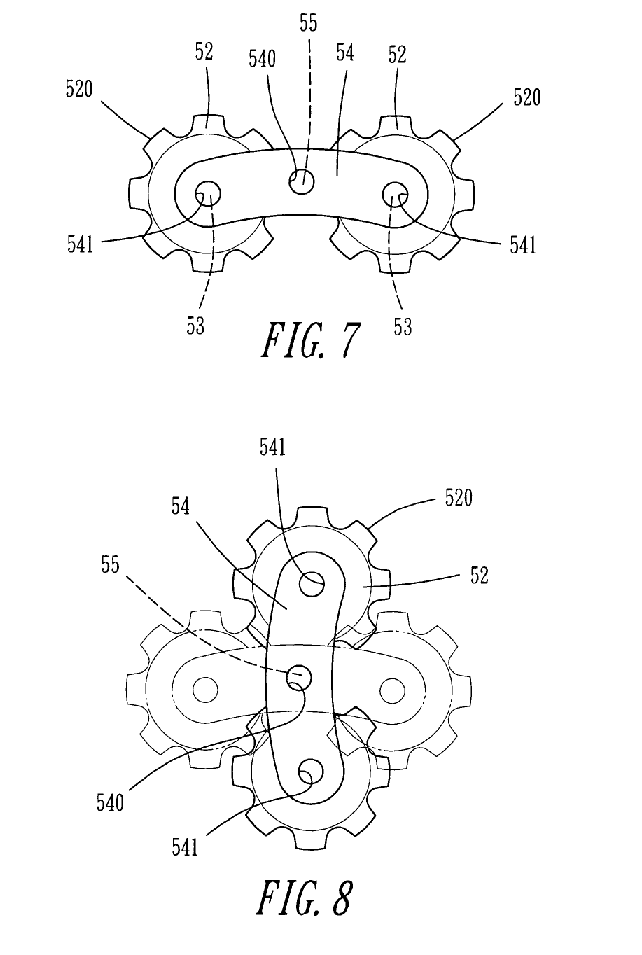

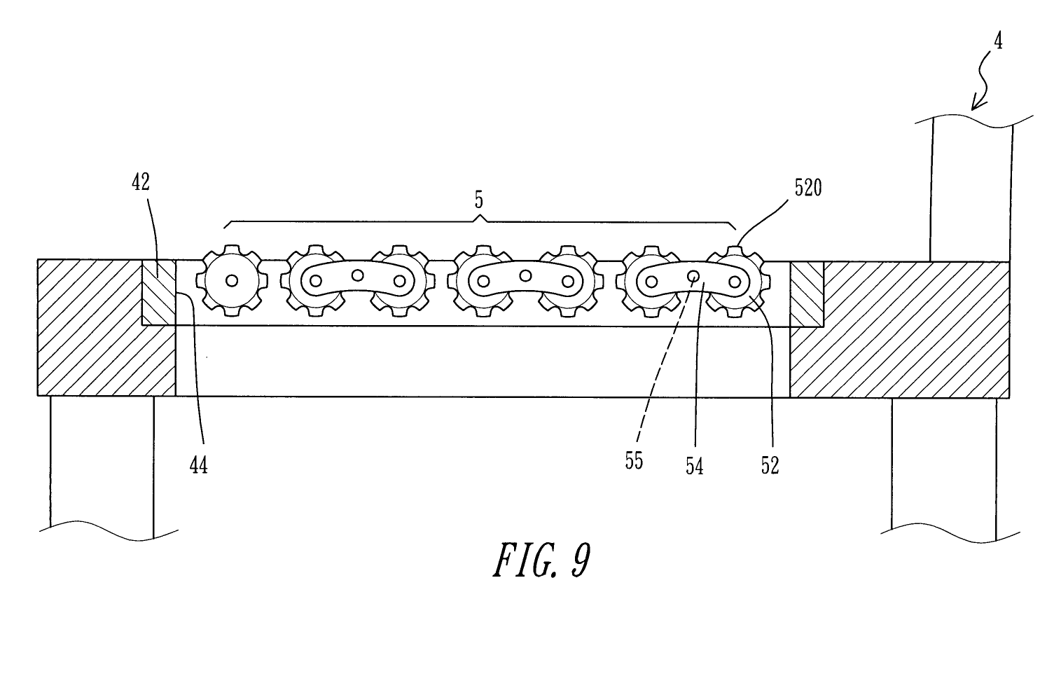

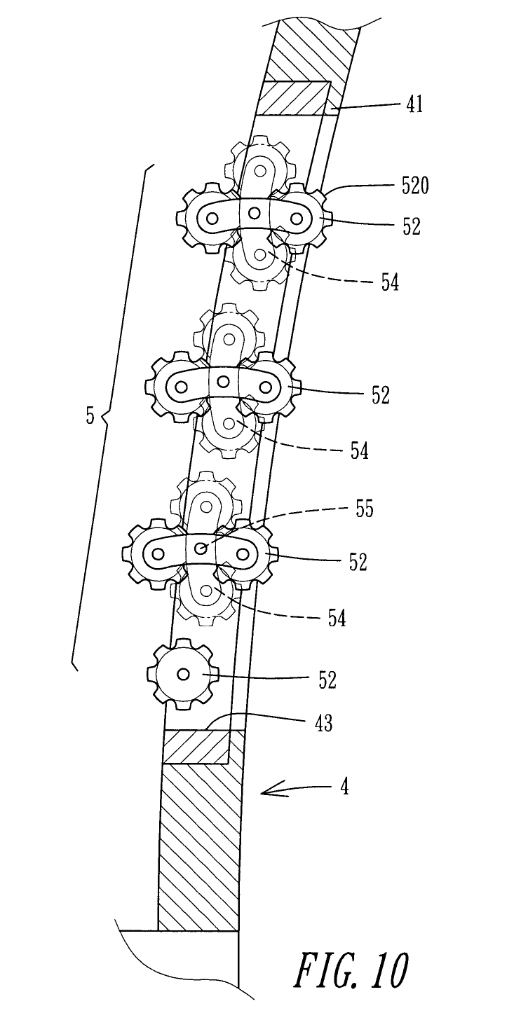

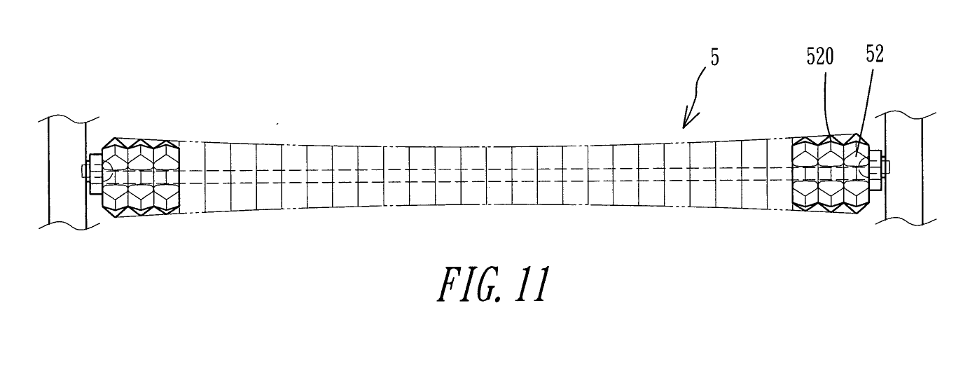

The double massage surfaces, as shown in FIGS. 6 and 7, are formed by the two independent shafts 53 with the two rows of the massage rollers 52, with a side connect plate 54 respectively positioned at two ends of the two rows of the massage rollers 52 and two short shafts 55 fitting in a center hole 540 of each side plate 54 for supporting the two rows of the massage rollers 52. The short shafts 55 can be substituted by a screw, a rivet, etc. Further, the side connect plate 54 has a curved-up upper and a curved-up lower edge, and a pivot hole 541 respectively at two sides of the center hole 540 for two ends of the elongate shaft 53 to fit pivotally therein. Further, the short shafts 55 are pivotally connected to the frame 51, to permit the two rows of the massage rollers 52 rotate with the short shafts 55 as pivots, as shown in FIG. 8. When the bottom or the back of a user rests on the massage device 5 in the backrest or the seat as shown in FIGS. 9 and 10, the massage surface of the massage device 5 may give rise to movement caused by rotation of the massage rollers 52 rotated by the movement of user's bottom or back so as to obtain massage function.

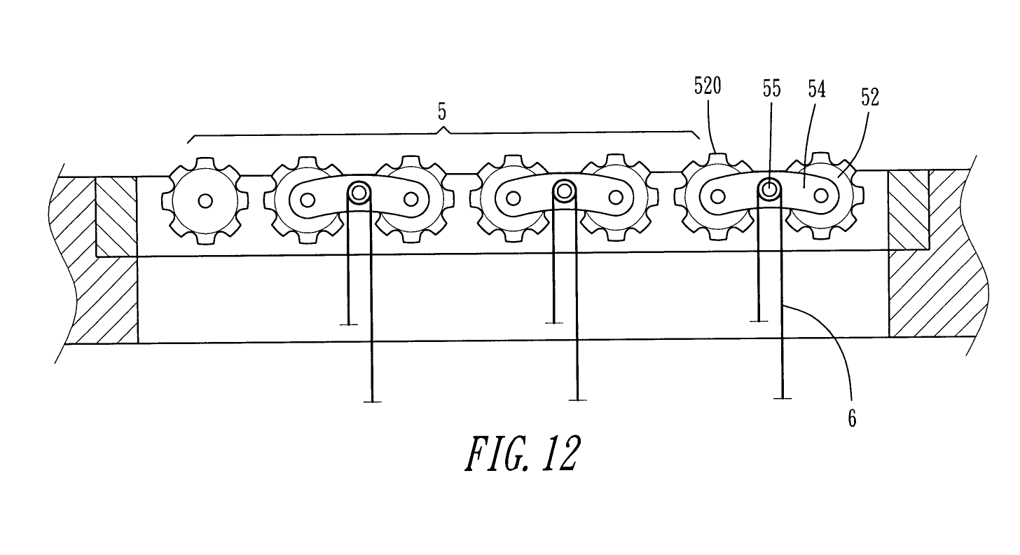

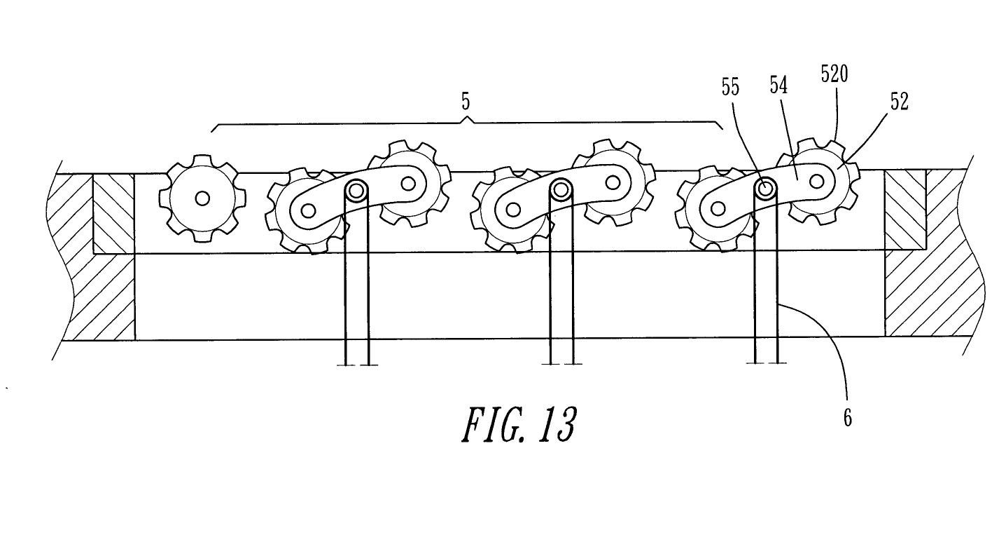

Next, as shown in FIG. 11, the whole massage surface formed by each row of the massage rollers 52 may be formed as a slow concave with one end sloping down to the center and then sloping up slowly to the other end. Then this surface is more comfortable for sitting thereon so as to receive better massage to a particular spot. Further, as shown in FIGS. 12 and 13, a transmitting member 6 may be added to extend around the center shaft 55, driven by a motor. Then the movement of the massage device 5 is automatically done, so the sitter of the chair does not need to move the bottom or the back for massaging.

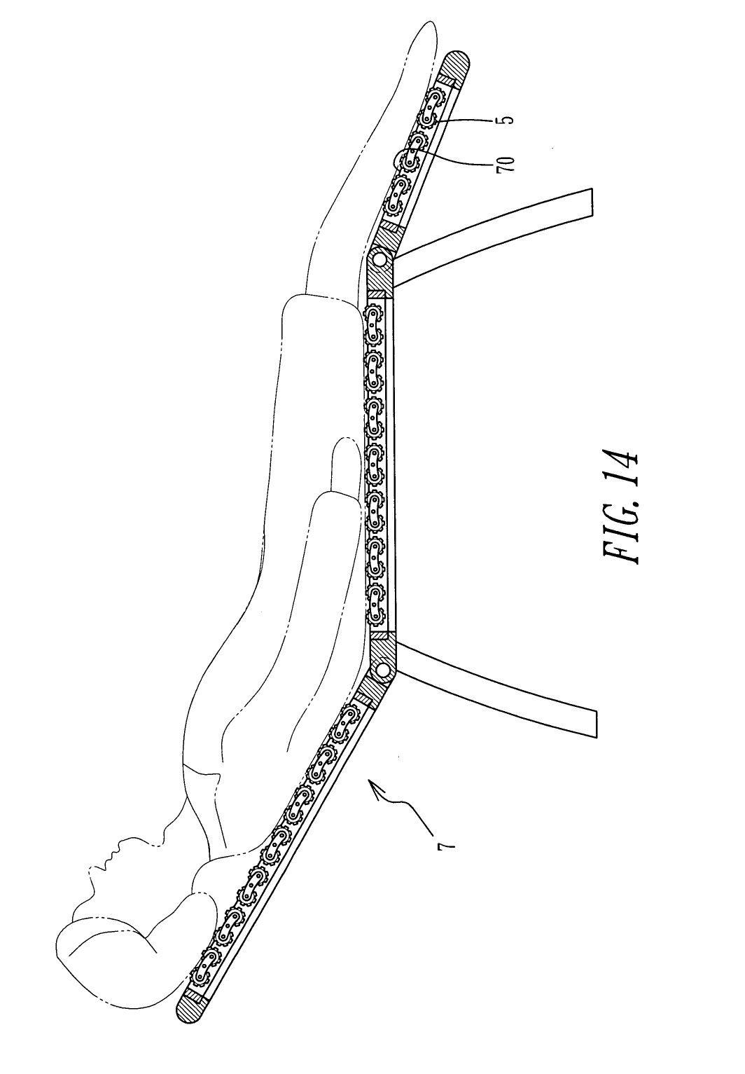

The massage device 5 in the invention may be applied to a footrest 70 of a chaise longue 7 as shown in FIG. 14, and then a user lying on the chaise longue 7 may make massage on the feet by means of the massage device 5.

The chair in the invention has the following advantages, compared with the conventional chairs.

1. The chair has a simple structure for both sitting and massaging, with a low cost, profitable for makers and affordable for consumers.

2. A user can make massage to any body part as the person needs, not as a conventional massage device massaging a definite location of a body, and the scope of the massage surface of the two rows of massage rollers can be selected as a user wants, not restricted as the conventional ones.

3. The massage device can be provided for massaging the head, the back, the bottom, the feet, etc. enhancing added function of massage to a chair.

While the preferred embodiment of the invention has been described above, it will be recognized and understood that various modifications may be made therein and the appended claims are intended to cover all such modifications that may fall within the spirit and scope of the invention.

1. A chair comprising a seat, and a massage device positioned in said seat, said massage device consisting of a frame and plural units of two rows of massage rollers, each said massage rollers having plural annular projections, an elongate shaft extending through a center hole of each said massage roller of each row, said elongate shaft having two ends pivotally connected to an inside wall of said frame, said massage rollers of each row forming a massage surface, two said elongate shafts extending through said massage rollers of the two rows in parallel, the two ends of said two rows of said massage rollers respectively pivotally connected to two side connect plates, each said side connect plate having a center hole for a center short shaft to fit pivotally therein, a pivot hole respectively formed at two sides of said center hole in each said side connect plate for two ends of each said elongate shaft to fit therein pivotally, said center short shafts connected pivotally to an inner side of said frame; said two rows of said massage rollers rotatable with said center short shafts functioning as pivots, said massage surface moving up and down caused by movement of the bottom of a user sitting on said seat of said chair so as to perform massage function to the user's body.

2 The chair as claimed in claim 1, wherein a transmitting means is further provided to extend around each said center short shaft, and said transmitting means is driven by a motor, so said massage rollers may be automatically rotated to permit the massage surface to move up and down to perform massage function to the user's bottom.

3. A chair comprising a backrest, and a massage device positioned in said backrest, said device consisting of a frame and plural units of two rows of massage rollers, each said massage roller having plural annular projections and a center hole, an elongate shaft extending through the center hole of each said massage roller of each row, said elongate shaft having two ends pivotally connected to an inside wall of said frame, all of said massage rollers of each row forming a massage surface, two said elongate shafts extending through said two rows of said massage rollers in parallel, two ends of said two rows of said massage rollers respectively pivotally connected to two side connect plates, each said side connect plate having a center hole for a center short shaft to fit pivotally therein, a pivot hole respectively formed at two sides of said center hole in each said side connect plate for two ends of each said elongate shaft to fit therein pivotally, said center short shafts connected pivotally to an inner side of said frame; said two rows of said massage rollers rotatable with said center short shafts functioning as pivots, said massage surface moving up and down by movement of the back of a sitter to perform massage function to the sitter's back.

4. The chair as claimed in claim 3, wherein a transmitting means is further provided to extend around each said center short shaft, and said transmitting means is driven by a motor, so said massage rollers may be automatically rotated to permit the massage surface to move up and down to perform massage function to the user's back

5. The chair comprising a footrest, and a massage device consisting of a frame and plural units of two rows of massage rollers, each said massage roller having plural annular projections and a center hole, an elongate shaft extending through the center hole of each said massage roller of each row, said elongate shaft having two ends pivotally connected to an inside wall of said frame, all of said massage rollers of each row forming a massage surface, two said elongate shafts extending through the two rows of said massage rollers in parallel, the two ends of said two rows of said massage rollers respectively pivotally connected to two side connect plates, each said side plate having a center hole for a center short shaft to fit pivotally therein, a pivot hole respectively formed at two sides of said center hole in each said side connect plate for two ends of two ends of each said elongate shaft to fit therein pivotally, said center short shafts connected pivotally to an inner side of said frame; said two rows of said massage rollers rotatable with said center short shafts functioning as pivots, said massage surface giving moving up and down by movement of the back of a sitter to perform massage function to the sitter's feet.

6. The chair as claimed in claim 5, wherein a transmitting means is further provided to extend around each said center short shaft, and said transmitting means is driven by a motor, so said massage rollers may be automatically rotated to permit the massage surface to move up and down to perform massage function to the user's feet.
